(19) United States
(12) Patent Application Publication
(10) Pub. No.: US 2026/0057319 A1
(43) Pub. Date: Feb. 26, 2026

(54) GOODS OUTBOUND METHOD AND PRODUCTS THEREOF

(71) Applicants: Guangzhou Xiyin International Import and Export Co., Ltd., Guangdong (CN); Shenzhen Xiyin Information Technology Co., Ltd., Guangdong (CN); Nanjing Xiyin Ecommerce Co., Ltd., Jiangsu (CN)

(72) Inventors: MENGYUAN WU, Guangdong (CN); ZHENYU SU, Guangdong (CN); SHIBO WANG, Guangdong (CN); TIANTIAN WANG, Guangdong (CN); MINGJUN CAI, Guangdong (CN); KIN MING KAM, Guangdong (CN); XINGGUO MA, Guangdong (CN)

(21) Appl. No.: 19/172,801

(22) Filed: Apr. 8, 2025

(30) Foreign Application Priority Data
Aug. 23, 2024 (CN) 2024111735185

(51) Int. Cl. G06Q 10/0631; G06Q 10/083; G06Q 10/087

(52) U.S. Cl. CPC G06Q 10/06314; G06Q 10/0838; G06Q 10/087

(57) ABSTRACT

A method for goods outbound includes predicting a time duration corresponding to each wave in each operation link of a goods outbound process, determining a capacity consumption duration of each wave in each operation link based on warehouse capacity information, determining a picking start time of each wave in each picking warehouse based on the time duration corresponding to each wave in each operation link and the capacity consumption duration of each wave in each operation link, and scheduling the picking of each wave based on the picking start time of each wave in each picking warehouse. Full use of the capacity of each link in the order outbound process is possible, waste of outbound capacity is avoided, the backlog of outbound goods is reduced, and the efficiency of order outbound is improved.

### CROSS REFERENCE TO RELATED APPLICATIONS AND CLAIM OF PRIORITY

This application claims the benefit under 35 USC § 119 of Chinese Patent Application No. 2024111735185 filed on Aug. 23, 2024, in the Chinese Intellectual Property Office, the entire disclosure of which is incorporated herein by reference for all purposes.

### BACKGROUND

### 1. Technical Fields

This application generally relates to the technical field of warehousing and logistics. More specifically, this application relates to a goods outbound method and related products.

### 2. Background Arts

E-commerce companies have a wide variety of goods and a large volume of outbound orders. To reduce picking costs and ensure the timeliness of goods outbound, wave picking is often employed to centrally pick goods for multiple orders. When wave picking is employed, the order outbound process involves a series of links including picking, consolidation, seeding, and packing. For large cross-border e-commerce companies, goods are usually stored in multiple warehouses, and goods of one order often need to be picked from multiple warehouses. To reduce transportation costs, it is necessary to consolidate the goods that need to be picked from each warehouse in the same wave, and then proceed with seeding and packing for outbound shipment.

However, since time taken for picking is different in each warehouse, and the time required to transport goods from different picking warehouses to the consolidation warehouse is also different, if each warehouse starts picking the order of a wave at the same time, the picked goods will arrive at the consolidation warehouse one after another. The consolidation warehouse then needs to wait until all the goods of the wave have arrived before it can start seeding and packing. If the waiting time at the consolidation warehouse is too long or unstable, it cannot be ensured that there are enough goods for seeding and packing, which would easily cause idle time for staff in subsequent links including seeding and packing, wasting capacity while occupying a large area of the consolidation warehouse.

To solve the above problem, in the current order goods outbound scheduling, after obtaining an expected consolidation time of the current wave, the picking and transfer time of the current wave in different picking warehouses can be predicted, and with the goal of having the goods from different picking warehouses of the same wave arrive at the consolidation warehouse at the same time, a picking start time of the current wave in different picking warehouses can be deduced, and then the priority order of picking scheduling for different waves in each picking warehouse can be determined based on the picking start time. However, due to capacity constraints of each link in the warehouse, when multiple waves are operating simultaneously, the deduced operation time of each link may deviate. Therefore, the existing scheduling methods are difficult to enable simultaneous consolidation of goods that are in the same wave and picked from different picking warehouses at the consolidation warehouse, and there are still problems such as unstable consolidation time, occupying a large area of the consolidation warehouse, and easily causing waste of subsequent outbound capacity.

In view of this, there is an urgent need to provide a goods outbound method to make full use of the capacity of each link in the order outbound process, avoid waste of outbound capacity, reduce the backlog of outbound goods, and improve the efficiency of order outbound.

### SUMMARY

To at least solve one or more of the technical problems as mentioned above, the application proposes a goods outbound method and related products in several aspects.

In a first aspect, the application provides a goods outbound method, including: predicting a time duration corresponding to each wave in each operation link of a goods outbound process; determining a capacity consumption duration of each wave in each operation link based on warehouse capacity information; determining a picking start time of each wave in each picking warehouse based on the time duration corresponding to each wave in each operation link and the capacity consumption duration of each wave in each operation link; and scheduling the picking of each wave based on the picking start time of each wave in each picking warehouse.

In some embodiments, the operation links a picking link, a transfer link, and a seeding link; wherein the predicting the time duration corresponding to each wave in each operation link of the goods outbound process includes: predicting the picking time duration of each wave in each picking warehouse in the picking link; predicting the transfer time duration of each wave from each picking warehouse to a consolidation warehouse in the transfer link; and predicting the seeding time duration of each wave in the seeding link.

In some embodiments, the predicting the picking time duration of each wave in each picking warehouse in the picking link includes: obtaining a historical picking time duration of each wave in each picking warehouse during a first historical period; obtaining a historical picking quantity of each wave in each picking warehouse during the first historical period; and determining the picking time duration of each wave in each picking warehouse based on the to-be-picked quantity of each wave in each picking warehouse, the historical picking time of each wave in each picking warehouse, and the historical picking quantity of each wave in each picking warehouse.

In some embodiments, the predicting the transfer time duration of each wave from each picking warehouse to the consolidation warehouse in the transfer link includes: obtaining transfer distance and transfer speed between each picking warehouse and the consolidation warehouse; and determining the transfer time duration of each wave from each picking warehouse to the consolidation warehouse based on the transfer distance and transfer speed between each picking warehouse and the consolidation warehouse.

In some embodiments, the predicting the seeding time duration of each wave in the seeding link includes: obtaining a historical seeding time of each wave during a second historical period; obtaining a historical seeding quantity of each wave during the second historical period; and determining the seeding time duration of each wave based on the to-be-seeded quantity of each wave, the historical seeding time of each wave, and the historical seeding quantity of each wave.

In some embodiments, the warehouse capacity information includes picking capacity information and seeding capacity information; wherein the determining the capacity consumption duration of each wave in each operation link based on warehouse capacity information includes: determining the picking capacity consumption duration of each wave in each picking warehouse based on the to-be-picked quantity of each wave in each picking warehouse and the picking capacity information; and determining the seeding capacity consumption duration of each wave based on the to-be-seeded quantity of each wave and the seeding capacity information.

In some embodiments, the determining the picking start time of each wave in each picking warehouse based on the time duration corresponding to each wave in each operation link and the capacity consumption duration of each wave in each operation link includes: setting constant parameters based on the time duration corresponding to each wave in each operation link and the capacity consumption duration of each wave in each operation link; setting variable parameters, the variable parameters including the picking start time of each wave in each picking warehouse; setting target parameters and constraint conditions based on the constant parameters and the variable parameters;

constructing a target mathematical model based on the constant parameters, the variable parameters, the target parameters, and the constraint conditions; and determining the picking start time of each wave in each picking warehouse through the target mathematical model.

In some embodiments, the scheduling the picking of each wave based on the picking start time of each wave in each picking warehouse includes: determining a priority sequence of each wave in each picking warehouse based on the picking start time of each wave in each picking warehouse; and scheduling the picking of each wave based on the priority sequence of each wave in each picking warehouse.

In a second aspect, the application provides a device for goods outbound, including: a memory; and at least one processor configured to: predict the time duration corresponding to each wave in each operation link of the goods outbound process; determine the capacity consumption duration of each wave in each operation link based on warehouse capacity information; determine the picking start time of each wave in each picking warehouse based on the time duration corresponding to each wave in each operation link and the capacity consumption duration of each wave in each operation link;

and schedule the picking of each wave based on the picking start time of each wave in each picking warehouse.

In a third aspect, the application provides a non-transitory machine-readable medium storing thereon program code for goods outbound, which, when executed by at least one processor, guide an execution operation of the at least one processor, the program code including: predicting the time duration corresponding to each wave in each operation link of the goods outbound process; determining the capacity consumption duration of each wave in each operation link based on warehouse capacity information;

determining the picking start time of each wave in each picking warehouse based on the time duration corresponding to each wave in each operation link and the capacity consumption duration of each wave in each operation link; and scheduling the picking of each wave based on the picking start time of each wave in each picking warehouse.

The technical solutions provided by the application may have the following favorable effects:

The goods outbound method and related products provided by the application predict a time duration corresponding to each wave in each operation link of the goods outbound process and determine a capacity consumption duration of each wave in each operation link based on warehouse capacity information, thereby obtaining predicted time duration information and actual capacity time consumption information of each operation link in the goods outbound process.

Furthermore, the embodiments of the application can determine a picking start time of each wave in each picking warehouse based on the time duration corresponding to each wave in each operation link and the capacity consumption duration of each wave in each operation link, and then schedule the picking of each wave based on the picking start time of each wave in each picking warehouse. This method simultaneously considers the predicted time duration information and actual capacity time consumption information of each operation link in the goods outbound process to infer a picking start time of each wave in each picking warehouse, improves the accuracy of the inferred picking start time, and ensures to the greatest extent the simultaneous consolidation of goods picked from different picking warehouses in the same wave at the consolidation warehouse, thereby improving the stability of the consolidation time, avoiding long-term and large-area occupation of the consolidation warehouse, and solving the problem of waste of subsequent outbound capacity.

In summary, the application can make full use of the capacity of each link in the order outbound process, avoid waste of outbound capacity, reduce the backlog of outbound goods, and improve the efficiency of order outbound.

### BRIEF DESCRIPTION OF THE DRAWINGS

By referring to the detailed description of the following drawings, the above and other purposes, features, and advantages of the exemplary embodiments of this application will become more understandable. In the drawings, several embodiments of this application are shown in an exemplary rather than restrictive manner, and the same or corresponding reference numerals indicate the same or corresponding parts, wherein:

FIG. 1 shows an exemplary flowchart of the goods outbound method according to some embodiments of this application;

FIG. 2 shows an exemplary flowchart of the goods outbound method according to other embodiments of this application;

FIG. 3 shows an exemplary flowchart of the goods outbound method according to further embodiments of this application; and

FIG. 4 shows a structural diagram of a device for goods outbound according to an embodiment of this application.

### DETAILED DESCRIPTION

The technical solutions in the embodiments of this application will be clearly and completely described below with reference to the drawings in the embodiments of this application. Obviously, the described embodiments are only a part of the embodiments of this application, rather than all of them. For the simplicity and clarity of the description, the same or corresponding reference numerals may be repeated in the drawings to indicate corresponding or similar elements. In addition, many specific details are set forth in this application to provide a thorough understanding of the embodiments described herein. However, those skilled in the art will understand that the embodiments described herein can be practiced without these specific details. In other cases, well-known methods, processes, and components are not described in detail to avoid obscuring the embodiments described herein. Moreover, the description should not be considered as limiting the scope of the embodiments described herein. Based on the embodiments in this application, all other embodiments obtained by those skilled in the art without creative labors shall fall within the protection scope of this application.

It should be understood that the possible term “first” or “second” in the claims, description, and drawings of this application is used to distinguish different objects, not to describe a specific order. The terms “including” and “comprising” used in the description and claims of this application indicate the existence of the described features, entities, steps, operations, elements, and/or components, but do not exclude the existence or addition of one or more other features, entities, steps, operations, elements, components, and/or their combinations.

It should also be understood that the terms used in the description of this application are only for the purpose of describing specific embodiments and are not intended to limit this application. As used in the description and claims of this application, unless the context clearly indicates otherwise, the singular forms “a”, “an”, and “the” are intended to include the plural forms. It should also be further understood that the term “and/or” used in the description and claims of this application refers to any combination of one or more of the associated listed items and all possible combinations, and includes these combinations.

As used in this specification and the claims, the term “if” may be interpreted as “when”, “once”, “in response to determining”, or “in response to detecting” depending on the context. Similarly, the phrase “if determined” or “if detected [described condition or event]” may be interpreted as “once determined”, “in response to determining”, “once detected [described condition or event]”, or “in response to detecting [described condition or event]” depending on the context.

For large cross-border e-commerce companies, to reduce transportation costs, it is necessary to consolidate the goods that need to be picked from each warehouse in the same wave, and then proceed with seeding and packing for outbound shipment. However, since the picking time in each warehouse is different, and the time required to transport goods from different picking warehouses to the consolidation warehouse is also different, the consolidation warehouse needs to wait until all the goods of the wave have arrived before it can start seeding and packing. If there are not enough goods for seeding and packing, it can easily cause idle time for staff in subsequent seeding and packing, wasting capacity while occupying a large area of the consolidation warehouse. According to the existing solutions, in order goods outbound scheduling, after obtaining the expected consolidation time of the current wave, the picking and transfer time of the current wave in different picking warehouses can be predicted to deduce the picking start time of the current wave in different picking warehouses, and then determine the priority order of picking scheduling for different waves in each picking warehouse based on the picking start time. However, due to the capacity constraints of each link in the warehouse, when multiple waves are operating simultaneously, the deduced operation time of each link may deviate, and the above problems cannot be well solved.

In view of this, there is an urgent need to provide a goods outbound method to make full use of the capacity of each link in the order outbound process, avoid waste of outbound capacity, reduce the backlog of outbound goods, and improve the efficiency of order outbound.

The specific implementation of this application will be described in detail below with reference to the drawings.

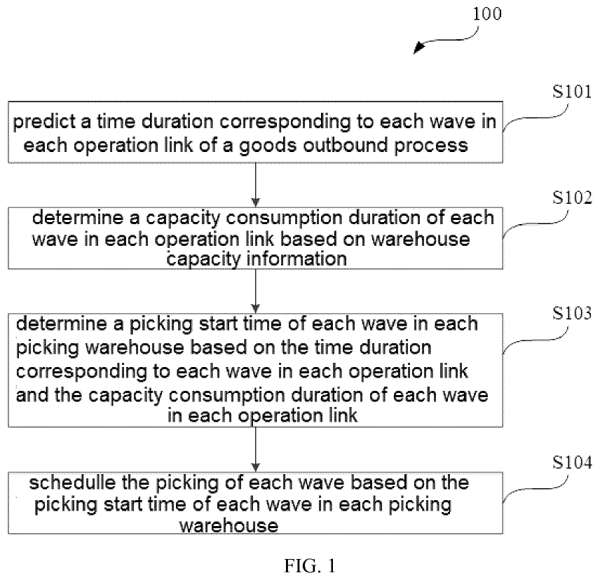

FIG. 1 shows an exemplary flowchart 100 of the goods outbound method according to some embodiments of this application. As shown in FIG. 1, the goods outbound method according to the embodiments of this application may include the following steps:

In step S101, a time duration corresponding to each wave in each operation link of the goods outbound process is predicted. The aforementioned wave is a concept in logistics and warehouse management, mainly referring to merging multiple orders into a batch according to certain standards for centralized processing to improve the efficiency of picking and shipping. In addition, the operation links of the goods outbound process may refer to a series of links required for goods outbound, including picking, consolidation, seeding, and packing. It can be understood that a certain period of time will be spent in each link to complete the corresponding operation, and the time spent can be predicted based on historical data, and thus, the corresponding time duration in each operation link can be estimated.

In step S102, capacity consumption duration of each wave in each operation link is determined based on warehouse capacity information. In the embodiments of this application, the aforementioned warehouse capacity information may refer to capacity efficiency information of each warehouse, such as an hourly picking capacity of each picking warehouse and an hourly seeding capacity of the consolidation warehouse, etc., which can be obtained by counting historical capacity data, such as a number of picked pieces in a certain period and a number of hours in that period, thereby obtaining the hourly picking capacity of the picking warehouse. The aforementioned capacity consumption duration may refer to a capacity time occupied by each wave in each operation link under the current capacity efficiency, which can be used to judge the capacity load of each operation link.

In step S103, a picking start time of each wave in each picking warehouse is determined based on the time duration corresponding to each wave in each operation link and the capacity consumption duration of each wave in each operation link. In the embodiments of this application, a mathematical model can be constructed based on the time duration corresponding to each wave in each operation link and the capacity consumption duration of each wave in each operation link to solve the picking start time of each wave in each picking warehouse, thereby simultaneously considering the predicted time duration information and actual capacity time consumption information of each operation link in the goods outbound process, avoiding the problem of inaccurate inference of the picking start time due to ignoring the warehouse capacity constraints in each operation link, and improving the accuracy of the inferred picking start time of each wave in each picking warehouse.

In step S104, picking of each wave is scheduled based on the picking start time of each wave in each picking warehouse. In the embodiments of this application, the picking scheduling of each wave can be arranged according to the picking start time of each wave in each picking warehouse, so as to ensure to the greatest extent simultaneous consolidation of goods picked from different picking warehouses in the same wave at the consolidation warehouse.

This application predicts the time duration corresponding to each wave in each operation link of the goods outbound process and determines the capacity consumption duration of each wave in each operation link based on warehouse capacity information, thereby obtaining the predicted time duration information and actual capacity time consumption information of each operation link in the goods outbound process.

Furthermore, the embodiments of this application can determine the picking start time of each wave in each picking warehouse based on the time duration corresponding to each wave in each operation link and the capacity consumption duration of each wave in each operation link, and then schedule the picking of each wave based on the picking start time of each wave in each picking warehouse. This can simultaneously consider the predicted time duration information and actual capacity time consumption information of each operation link in the goods outbound process to infer the picking start time of each wave in each picking warehouse, improve the accuracy of the inferred picking start time, and ensure to the greatest extent simultaneous consolidation of goods picked from different picking warehouses in the same wave at the consolidation warehouse, thereby improving the stability of the consolidation time, avoiding long-term and large-area occupation of the consolidation warehouse, and solving the problem of waste of subsequent outbound capacity.

In summary, this application can make full use of capacity of each link in the order outbound process, avoid waste of outbound capacity, reduce the backlog of outbound goods, and improve the efficiency of order outbound.

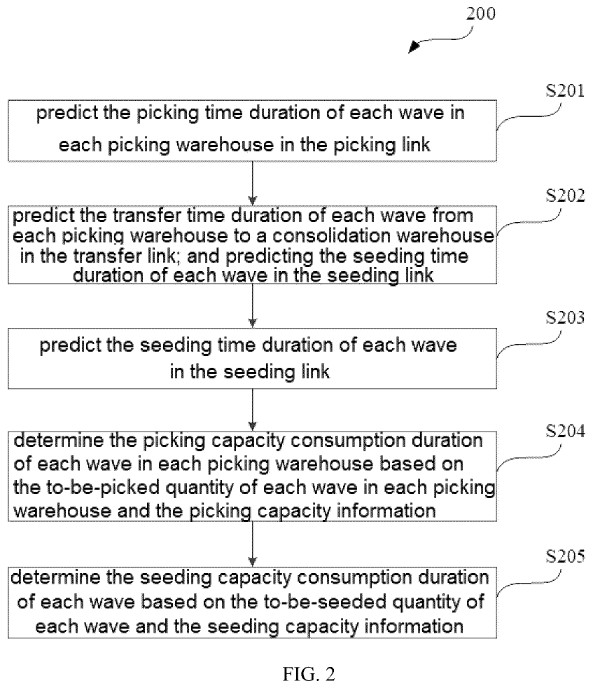

In some embodiments, the operation links may include but are not limited to ta picking link, a transfer link, and a seeding link, and the corresponding time duration of each of the aforementioned links can be determined respectively. In addition, the warehouse capacity information may include but is not limited to picking capacity information and seeding capacity information, and the aforementioned capacity information can be used to determine the capacity consumption duration of the picking link and the seeding link respectively. In the following text, the determination process of the corresponding time duration of the aforementioned links and the determination process of the capacity consumption duration of the picking link and the seeding link will be described in detail with reference to FIG. 2. FIG. 2 shows an exemplary flowchart 200 of the goods outbound method according to other embodiments of this application. As shown in FIG. 2, the goods outbound method according to the embodiments of this application may include the following steps:

In step S201, a picking time duration of each wave in each picking warehouse in the picking link is determined. In the embodiments of this application, a historical picking time of each wave in each picking warehouse during a first historical period can be obtained first, and a historical picking quantity of each wave in each picking warehouse during the first historical period can also be obtained, and then the picking time duration of each wave in each picking warehouse can be determined based on the to-be-picked quantity of each wave in each picking warehouse, the historical picking time of each wave in each picking warehouse, and the historical picking quantity of each wave in each picking warehouse. For example, the picking time duration of each wave in each picking warehouse in the picking link can be predicted according to the following Formula 1:

$${tp}_{i , w} = \frac{{tph}_{i , w}}{{nph}_{i , w}} \times {np}_{i , w} \qquad ( Formula I )$$

where, tp_{i,w} is a picking time duration of the i-th wave in the w-th picking warehouse, tph_{i,w} is a historical picking time of the i-th wave in the w-th picking warehouse during a first historical period, nph_{i,w} is a historical picking quantity of the i-th wave in the w-th picking warehouse during the first historical period, and np_{i,w} is a to-be-picked quantity of the i-th wave in the w-th picking warehouse. In the embodiments of this application, the first historical period can be illustratively set to 24 hours. It can be understood that in practical applications, the prediction method of the picking time duration of each wave in each picking warehouse in the picking link can be determined according to the actual application condition, and the setting value of the first historical period can also be determined according to the actual application condition, which are not limited in this application.

In step S202, a transfer time duration of each wave from each picking warehouse to the consolidation warehouse in the transfer link is predicted. In the embodiments of this application, transfer distance and transfer speed between each picking warehouse and the consolidation warehouse can be obtained first, where the transfer distance between each picking warehouse and the consolidation warehouse can be obtained by measuring a distance of the transportation route between each picking warehouse and the consolidation warehouse. In addition, the transfer speed between each picking warehouse and the consolidation warehouse can be obtained by first counting the transfer time between each picking warehouse and the consolidation warehouse to obtain an average transfer time, and then dividing the measured distance by the average transfer time to obtain the transfer speed from each picking warehouse to the consolidation warehouse.

Furthermore, the transfer time duration of each wave from each picking warehouse to the consolidation warehouse can be determined based on the transfer distance and transfer speed between each picking warehouse and the consolidation warehouse. For example, the transfer time duration of each wave from each picking warehouse to the consolidation warehouse can be predicted according to the following Formula 2:

$${tt}_{i , w} = \frac{{l}_{w}}{{v}_{w}} \qquad ( Formula 2 )$$

where, tt_{i,w} is the transfer time duration of the i-th wave from the w-th picking warehouse to the consolidation warehouse, l_{w} is the transfer distance between the w-th picking warehouse and the consolidation warehouse, and vw is the transfer speed between the w-th picking warehouse and the consolidation warehouse.

It can be understood that in practical applications, the prediction method of the transfer time duration of each wave from each picking warehouse to the consolidation warehouse can be determined according to the actual application condition, which is not limited in this application.

In step S203, a seeding time duration of each wave in the seeding link is predicted. In the embodiments of this application, the seeding link can be carried out in the consolidation warehouse, and the historical seeding time corresponding to each wave during a second historical period can be obtained first, and a historical seeding quantity of each wave during the second historical period can also be obtained, and then the seeding time duration of each wave can be determined based on the to-be-seeded quantity of each wave, the historical seeding time of each wave, and the historical seeding quantity of each wave. For example, the seeding time duration of each wave can be predicted according to the following Formula 3:

$${ts}_{i} = \frac{{tsh}_{i}}{{nsh}_{i}} \times {ns}_{i} \qquad ( Formula 3 )$$

where, tsᵢ is a seeding time duration of the i-th wave, tshᵢ is a historical seeding time of the i-th wave during the second historical period, nshᵢ is a historical seeding quantity of the i-th wave during the second historical period, and nsᵢ is the to-be-seeded quantity of the i-th wave. In the embodiments of this application, the second historical period can be illustratively set to 24 hours. It can be understood that in practical applications, the prediction method of the seeding time duration of each wave can be determined according to the actual application condition, and the setting value of the second historical period can also be determined according to the actual application situation, which are not limited in this application.

It can be understood that the above steps S201 to S203 can be executed sequentially or concurrently, without any strict time sequence limit, which needs to be determined according to the actual application condition and is not limited in this application.

In step S204, a picking capacity consumption duration of each wave in each picking warehouse is determined based on the to-be-picked quantity of each wave in each picking warehouse and the picking capacity information. For example, the picking capacity consumption duration of each wave in each picking warehouse can be determined according to the following Formula 4:

$${tcp}_{i , w} = \frac{{np}_{i , w}}{{cp}_{w}} \qquad ( Formula 4 )$$

where, tcp_{i,w} is a picking capacity consumption duration of the i-th wave in the w-th picking warehouse, np_{i,w} is a to-be-picked quantity of the i-th wave in the w-th picking warehouse, and cp_{i,w} is a picking capacity information of the w-th picking warehouse, such as an hourly picking capacity of the w-th picking warehouse.

In step S205, a seeding capacity consumption duration of each wave is determined based on the to-be-seeded quantity of each wave and the seeding capacity information. For example, the seeding capacity consumption duration of each wave can be determined according to the following Formula 5:

$${tcs}_{i} = \frac{{ns}_{i}}{cs} \qquad ( Formula 5 )$$

where, tcsᵢ is a seeding capacity consumption duration of the i-th wave, nsᵢ is a to-be-seeded quantity of the i-th wave, and cs is seeding capacity information, such as an hourly seeding capacity of the consolidation warehouse.

It can be understood that the above steps S204 to S205 can be executed sequentially or concurrently, without any strict time sequence limit, which needs to be determined according to the actual application condition and is not limited in this application.

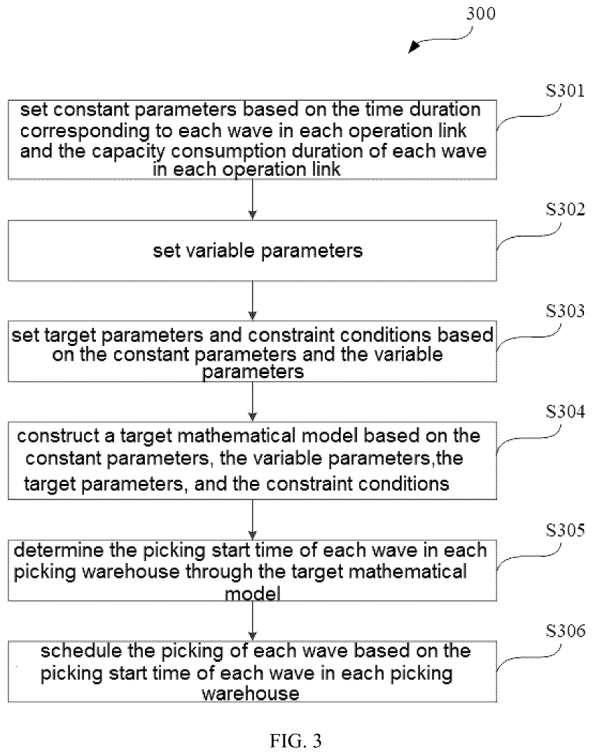

In some embodiments, a picking start time of each wave in each picking warehouse can be determined by constructing a target mathematical model, and then scheduling picking of each wave based on the picking start time of each wave in each picking warehouse. The determination process of the picking start time will be described in detail below with reference to FIG. 3. FIG. 3 shows an exemplary flowchart 300 of the goods outbound method according to further embodiments of this application. As shown in FIG. 3, the goods outbound method according to the embodiments of this application may include the following steps:

In step S301, constant parameters are set based on the time duration corresponding to each wave in each operation link and the capacity consumption duration of each wave in each operation link. Specifically, the picking time duration tp_{i,w} of the i-th wave in the w-th picking warehouse, the picking capacity consumption duration tcp_{i,w} of the i-th wave in the w-th picking warehouse, the transfer time duration tt_{i,w} of the i-th wave from the w-th picking warehouse to the consolidation warehouse, the seeding time duration tsᵢ of the i-th wave, the seeding capacity consumption duration tcsᵢ of the i-th wave, and a sufficiently large normal number M described above can be set as constant parameters.

In step S302, variable parameters are set. The variable parameters include the picking start time of each wave in each picking warehouse. Specifically, the picking start time xp_{i,w} of the i-th wave in the w-th picking warehouse, the seeding start time xsᵢ of the i-th wave, the latest seeding completion time Cₘₐₓ of all waves, the judgment result Zp_{i,j,w} of whether the i-th wave is picked before the j-th wave in the w-th picking warehouse (if yes, the value of Zp_{i,j,w} is 1, and if no, the value of Zp_{i,j,w} is 0), the judgment result Zs_{i,j} of whether the i-th wave is seeded before the j-th wave (if yes, the value of Zs_{i,j} is 1, and if no, the value of Zs_{i,j} is 0), and the seeding start time difference di between the i-th wave and the i+1-th wave can be set as variable parameters.

In step S303, target parameters and constraint conditions are set based on the constant parameters and variable parameters. In the embodiments of this application, three target parameters can be set, which are:
(1) Minimize Cₘₐₓ (minimizing the latest seeding completion time of all waves);
(2) Minimize Σxsᵢ+tsᵢ−xp_{i,w} (minimizing the time duration from the start of picking to the completion of seeding for each wave);
(3) Minimize Σdᵢ (minimizing the sum of the seeding start time differences between each wave).

In addition, in the embodiments of this application, five constraint conditions can be set, which are:
\textcircled{1}xp_{i,w}+tt_{i,w}+tp_{i,w}≤xsᵢ (the seeding start time is after the completion of picking and transfer arrival time)

$$\{ \begin{matrix}{xp}_{i , w} \geq {xp}_{j , w} + {tcp}_{j , w} - {Zp}_{i , j , w} \times M \\ {xp}_{j , w} \geq {xp}_{i , w} + {tcp}_{i , w} - ( 1 - {Zp}_{i , j , w} ) \times M\end{matrix} \qquad ( 2 )$$

(the time periods of picking capacity occupied by the i-th wave and the j-th wave in the w-th picking warehouse do not overlap)

$$\{ \begin{matrix}{xs}_{i} \geq {xs}_{j} + {tcs}_{j} - {Zs}_{i , j} \times M \\ {xs}_{j} \geq {xs}_{i} + {tcs}_{i} - ( 1 - {Zs}_{i , j} ) \times M\end{matrix} \qquad ( 3 )$$

(the time periods of seeding capacity occupied by the i-th wave and the j-th wave do not overlap)
\textcircled{4}cₘₐₓ≥xsᵢ+tsᵢ (the latest seeding completion time is greater than or equal to the seeding completion time of each wave)
\textcircled{5}xsᵢ−dᵢ<xsᵢ₊₁ (the seeding start time of the earlier created wave i is less than or equal to the seeding start time of the later created wave i+1)

In step S304, a target mathematical model is constructed based on the constant parameters, variable parameters, target parameters, and constraint conditions. In the embodiments of this application, the target mathematical model can be constructed by combining the above constant parameters, variable parameters, target parameters, and constraint conditions.

In step S305, a picking start time of each wave in each picking warehouse is determined through the target mathematical model. In the embodiments of this application, the solution of the target mathematical model is a Mixed Integer Programming (MIP) problem, which can be solved by a mathematical programming solver, or can be searched by a heuristic or meta-heuristic algorithm, thereby determining the most suitable picking start time of each wave in each picking warehouse.

In step S306, picking of each wave is scheduled based on the picking start time of each wave in each picking warehouse. In the embodiments of this application, the priority sequence of each wave in each picking warehouse can be determined based on the picking start time of each wave in each picking warehouse, and then scheduling picking of each wave based on the priority sequence of each wave in each picking warehouse. This can ensure to the greatest extent simultaneous consolidation of goods picked from different picking warehouses in the same wave at the consolidation warehouse, improve the stability of the consolidation time, avoid long-term and large-area occupation of the consolidation warehouse, and solve the problem of waste of subsequent outbound capacity.

Corresponding to the aforementioned application function implementation method embodiments, this application also provides a device for goods outbound and corresponding embodiments.

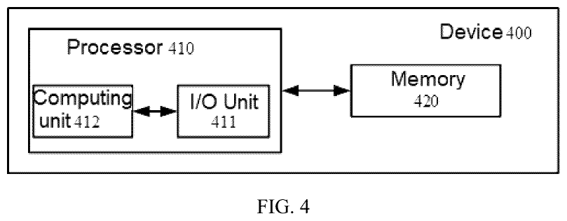

FIG. 4 shows a structural diagram of a device 400 for goods outbound according to an embodiment of this application. As shown in FIG. 4, the device 400 for goods outbound may include a processor 410 and a memory 420. In the device 400 for goods outbound shown in FIG. 4, only the components related to this embodiment are shown. Therefore, it is obvious to those skilled in the art that the device 400 for goods outbound may also include common components different from those shown in FIG. 4, such as: a fixed-point arithmetic unit.

The device 400 for goods outbound may correspond to a computing device with various processing functions, such as functions of generating a neural network, training or learning a neural network, quantizing a floating-point neural network into a fixed-point neural network, or retraining a neural network. For example, the device 400 for goods outbound can be implemented as various types of devices, such as a personal computer (PC), a server device, a mobile device, etc.

The processor 410 controls all functions of the device 400 for goods outbound. For example, the processor 410 controls all functions of the device 400 for goods outbound by executing programs stored in a memory 420 of the device 400 for goods outbound. The processor 410 can be implemented by a central processing unit (CPU), a graphics processing unit (GPU), an application processor (AP), an artificial intelligence processor chip (IPU), etc. provided on the device 400 for goods outbound. However, this application is not limited to this.

In some embodiments, the processor 410 may include an input/output (I/O) unit 411 and a computing unit 412. The I/O unit 411 can be used to receive various data. For example, the computing unit 412 can be used to predict the time duration corresponding to each wave in each operation link of the goods outbound process; determine the capacity consumption duration of each wave in each operation link based on warehouse capacity information; determine the picking start time of each wave in each picking warehouse based on the time duration corresponding to each wave in each operation link and the capacity consumption duration of each wave in each operation link; and schedule the picking of each wave based on the picking start time of each wave in each picking warehouse. The picking start time of each wave in each picking warehouse can be outputted by, for example, the I/O unit 411. The output data can be provided to the memory 420 for other devices (not shown) to read and use, or can be directly provided to other devices for use.

The memory 420 is hardware for storing various data processed in the device 400 for goods outbound. For example, the memory 420 can store processed data and data to be processed in the device 400 for goods outbound. The memory 420 can store the data set involved in the goods outbound method processed or to be processed by the processor 410, such as the time duration corresponding to each wave in each operation link of the goods outbound process. In addition, the memory 420 can store applications, drivers, etc. to be driven by the device 400 for goods outbound. For example: the memory 420 can store various programs related to the goods outbound method to be executed by the processor 410. The memory 420 can be DRAM, but this application is not limited to this. The memory 420 can include at least one of a volatile memory or a non-volatile memory. The non-volatile memory can include a read-only memory (ROM), a programmable ROM (PROM), an electrically programmable ROM (EPROM), an electrically erasable programmable ROM (EEPROM), a flash memory, a phase-change RAM (PRAM), a magnetic RAM (MRAM), a resistive RAM (RRAM), a ferroelectric RAM (FRAM), etc. The volatile memory can include a adynamic RAM (DRAM), static RAM (SRAM), a synchronous DRAM (SDRAM), a PRAM, an MRAM, an RRAM, a ferroelectric RAM (FeRAM), etc. In the embodiments, the memory 420 can include at least one of a hard disk drive (HDD), a solid-state drive (SSD), a compact flash (CF), a secure digital (SD) card, a micro secure digital (Micro-SD) card, a mini secure digital (Mini-SD) card, an extreme digital (xD) card, caches, or a memory stick.

In summary, the specific functions implemented by the memory 420 and the processor 410 of the device 400 for goods outbound provided by the embodiments of this specification can be compared and explained with the aforementioned embodiments in this specification, and can achieve the technical effects of the aforementioned embodiments, which will not be repeated here.

In this embodiment, the processor 410 can be implemented in any appropriate manner. For example, the processor 410 can take the form of a microprocessor or a processor and a computer-readable medium storing computer-readable program code (such as software or firmware) that can be executed by the (micro) processor, logic gates, switches, an Application-Specific Integrated Circuit (ASIC), a programmable logic controller, and an embedded microcontroller.

It should also be understood that any module, unit, component, server, computer, terminal, or device that executes instructions in the examples herein may include or otherwise access a computer-readable medium, such as a storage medium, a computer storage medium, or a data storage device (removable and/or non-removable), such as a magnetic disk, an optical disk, or a magnetic tape. The computer storage medium may include volatile and non-volatile, removable and non-removable media implemented in any method or technology for storing information, such as computer-readable instructions, data structures, program modules, or other data.

The foregoing content can be better understood according to the following clauses:
Clause A1. A method for goods outbound, including: predicting a time duration corresponding to each wave in each operation link of a goods outbound process; determining a capacity consumption duration of each wave in each operation link based on warehouse capacity information; determining a picking start time of each wave in each picking warehouse based on the time duration corresponding to each wave in each operation link and the capacity consumption duration of each wave in each operation link; and scheduling the picking of each wave based on the picking start time of each wave in each picking warehouse.
Clause A2. The method according to Clause A1, wherein the operation links include a picking link, a transfer link, and a seeding link; wherein the predicting the time duration corresponding to each wave in each operation link of the goods outbound process includes: predicting the picking time duration of each wave in each picking warehouse in the picking link; predicting the transfer time duration of each wave from each picking warehouse to a consolidation warehouse in the transfer link; and predicting the seeding time duration of each wave in the seeding link.
Clause A3. The method according to Clause A2, wherein the predicting the picking time duration of each wave in each picking warehouse in the picking link includes: obtaining a historical picking time duration of each wave in each picking warehouse during a first historical period; obtaining a historical picking quantity of each wave in each picking warehouse during the first historical period; and determining the picking time duration of each wave in each picking warehouse based on the to-be-picked quantity of each wave in each picking warehouse, the historical picking time of each wave in each picking warehouse, and the historical picking quantity of each wave in each picking warehouse.
Clause A4. The method according to Clause A2, wherein the predicting the transfer time duration of each wave from each picking warehouse to the consolidation warehouse in the transfer link includes: obtaining transfer distance and transfer speed between each picking warehouse and the consolidation warehouse; and determining the transfer time duration of each wave from each picking warehouse to the consolidation warehouse based on the transfer distance and transfer speed between each picking warehouse and the consolidation warehouse.
Clause A5. The method according to Clause A2, wherein the predicting the seeding time duration of each wave in the seeding link includes: obtaining a historical seeding time of each wave during a second historical period; obtaining a historical seeding quantity of each wave during the second historical period; and determining the seeding time duration of each wave based on the to-be-seeded quantity of each wave, the historical seeding time of each wave, and the historical seeding quantity of each wave.
Clause A6. The method according to Clause A1, wherein the warehouse capacity information includes picking capacity information and seeding capacity information; wherein the determining the capacity consumption duration of each wave in each operation link based on warehouse capacity information includes: determining the picking capacity consumption duration of each wave in each picking warehouse based on the to-be-picked quantity of each wave in each picking warehouse and the picking capacity information; and determining the seeding capacity consumption duration of each wave based on the to-be-seeded quantity of each wave and the seeding capacity information.
Clause A7. The method according to Clause A1, wherein the determining the picking start time of each wave in each picking warehouse based on the time duration corresponding to each wave in each operation link and the capacity consumption duration of each wave in each operation link includes: setting constant parameters based on the time duration corresponding to each wave in each operation link and the capacity consumption duration of each wave in each operation link; setting variable parameters, the variable parameters including the picking start time of each wave in each picking warehouse; setting target parameters and constraint conditions based on the constant parameters and the variable parameters; constructing a target mathematical model based on the constant parameters, the variable parameters, the target parameters, and the constraint conditions; and determining the picking start time of each wave in each picking warehouse through the target mathematical model.
Clause A8. The method according to Clause A1, wherein the scheduling the picking of each wave based on the picking start time of each wave in each picking warehouse includes: determining a priority sequence of each wave in each picking warehouse based on the picking start time of each wave in each picking warehouse; and scheduling the picking of each wave based on the priority sequence of each wave in each picking warehouse.
Clause A9. A device for goods outbound, including: a memory; and at least one processor configured to: predict the time duration corresponding to each wave in each operation link of the goods outbound process; determine the capacity consumption duration of each wave in each operation link based on warehouse capacity information; determine the picking start time of each wave in each picking warehouse based on the time duration corresponding to each wave in each operation link and the capacity consumption duration of each wave in each operation link; and schedule the picking of each wave based on the picking start time of each wave in each picking warehouse.
Clause A9. A non-transitory machine-readable medium storing thereon program code for goods outbound, which, when executed by at least one processor, guide an execution operation of the at least one processor, the program code including: predicting the time duration corresponding to each wave in each operation link of the goods outbound process; determining the capacity consumption duration of each wave in each operation link based on warehouse capacity information; determining the picking start time of each wave in each picking warehouse based on the time duration corresponding to each wave in each operation link and the capacity consumption duration of each wave in each operation link; and scheduling the picking of each wave based on the picking start time of each wave in each picking warehouse.

Although multiple embodiments of this application have been shown and described herein, it is obvious to those skilled in the art that such embodiments are provided by way of example only. Those skilled in the art can think of many changes, modifications, and substitutions without departing from the spirit and scope of this application. It should be understood that various alternative solutions to the embodiments of this application described herein can be adopted in the practice of this application. The 5 appended claims are intended to define the scope of this application and thus cover alternatives or equivalents within the scope of these claims.

What is claimed is:

1. A method for goods outbound, comprising:
predicting a time duration corresponding to each wave in each operation link of a goods outbound process;
determining a capacity consumption duration of each wave in each operation link based on warehouse capacity information;
determining a picking start time of each wave in each picking warehouse based on the time duration corresponding to each wave in each operation link and the capacity consumption duration of each wave in each operation link; and
scheduling the picking of each wave based on the picking start time of each wave in each picking warehouse.

2. The method for goods outbound according to claim 1, wherein the operation links include a picking link, a transfer link, and a seeding link; wherein the predicting the time duration corresponding to each wave in each operation link of the goods outbound process includes:
predicting the picking time duration of each wave in each picking warehouse in the picking link;
predicting the transfer time duration of each wave from each picking warehouse to a consolidation warehouse in the transfer link; and
predicting the seeding time duration of each wave in the seeding link.

3. The method for goods outbound according to claim 2, wherein the predicting the picking time duration of each wave in each picking warehouse in the picking link includes:
obtaining a historical picking time duration of each wave in each picking warehouse during a first historical period;
obtaining a historical picking quantity of each wave in each picking warehouse during the first historical period; and
determining the picking time duration of each wave in each picking warehouse based on the to-be-picked quantity of each wave in each picking warehouse, the historical picking time of each wave in each picking warehouse, and the historical picking quantity of each wave in each picking warehouse.

4. The method for goods outbound according to claim 2, wherein the predicting the transfer time duration of each wave from each picking warehouse to the consolidation warehouse in the transfer link includes:
obtaining transfer distance and transfer speed between each picking warehouse and the consolidation warehouse; and
determining the transfer time duration of each wave from each picking warehouse to the consolidation warehouse based on the transfer distance and transfer speed between each picking warehouse and the consolidation warehouse.

5. The method for goods outbound according to claim 2, wherein the predicting the seeding time duration of each wave in the seeding link includes:
obtaining a historical seeding time of each wave during a second historical period;
obtaining a historical seeding quantity of each wave during the second historical period; and
determining the seeding time duration of each wave based on the to-be-seeded quantity of each wave, the historical seeding time of each wave, and the historical seeding quantity of each wave.

6. The method for goods outbound according to claim 1, wherein the warehouse capacity information includes picking capacity information and seeding capacity information; wherein the determining the capacity consumption duration of each wave in each operation link based on warehouse capacity information includes:
determining the picking capacity consumption duration of each wave in each picking warehouse based on the to-be-picked quantity of each wave in each picking warehouse and the picking capacity information; and
determining the seeding capacity consumption duration of each wave based on the to-be-seeded quantity of each wave and the seeding capacity information.

7. The method for goods outbound according to claim 1, wherein the determining the picking start time of each wave in each picking warehouse based on the time duration corresponding to each wave in each operation link and the capacity consumption duration of each wave in each operation link includes:
setting constant parameters based on the time duration corresponding to each wave in each operation link and the capacity consumption duration of each wave in each operation link;
setting variable parameters, the variable parameters including the picking start time of each wave in each picking warehouse;
setting target parameters and constraint conditions based on the constant parameters and the variable parameters;
constructing a target mathematical model based on the constant parameters, the variable parameters, the target parameters, and the constraint conditions; and
determining the picking start time of each wave in each picking warehouse through the target mathematical model.

8. The method for goods outbound according to claim 1, wherein the scheduling the picking of each wave based on the picking start time of each wave in each picking warehouse includes:
determining a priority sequence of each wave in each picking warehouse based on the picking start time of each wave in each picking warehouse; and
scheduling the picking of each wave based on the priority sequence of each wave in each picking warehouse.

9. A device for goods outbound, comprising:
a memory; and
at least one processor configured to:
predict the time duration corresponding to each wave in each operation link of the goods outbound process;
determine the capacity consumption duration of each wave in each operation link based on warehouse capacity information;
determine the picking start time of each wave in each picking warehouse based on the time duration corresponding to each wave in each operation link and the capacity consumption duration of each wave in each operation link; and
schedule the picking of each wave based on the picking start time of each wave in each picking warehouse.

10. A non-transitory machine-readable medium storing thereon program code for goods outbound, which, when executed by at least one processor, guide an execution operation of the at least one processor, the program code comprising:
predicting the time duration corresponding to each wave in each operation link of the goods outbound process;
determining the capacity consumption duration of each wave in each operation link based on warehouse capacity information;
determining the picking start time of each wave in each picking warehouse based on the time duration corresponding to each wave in each operation link and the capacity consumption duration of each wave in each operation link; and
scheduling the picking of each wave based on the picking start time of each wave in each picking warehouse.
